(19) United States
(12) Patent Application Publication
(10) Pub. No.: US 2015/0300386 A1
(43) Pub. Date: Oct. 22, 2015

(54) Hinged Mounting Clamp System

(71) Applicant: Micro World Corp., Arcadia, CA (US)

(72) Inventors: H. G. Robert Fong, Los Angeles, CA (US); Joseph Romero, Pomona, CA (US)

(21) Appl. No.: 14/629,667

(22) Filed: Feb. 24, 2015

Related U.S. Application Data
(60) Provisional application No. 61/946,679, filed on Feb. 28, 2014.

(51) Int. Cl. F16B 2/10; F16M 13/02

(52) U.S. Cl. CPC F16B 2/10; F16M 13/022

(57) ABSTRACT

A mounting apparatus is provided. This mounting apparatus, or sometimes referred to as an apparatus or hinged mounting clamp system, may include a member, or referenced for convenience herein as a pivoting clamp arm, configured so as to grasp a mounting rail or similar structure. The pivoting clamp arm may also be spring loaded. A threaded locking bolt or similar component may also be used to assist one or more springs to apply force to the pivoting clamp arm to assist in the grasping of a mounting rail or similar structure. A related method is also provided.

### PRIORITY CLAIM

This application claims priority to Provisional Patent Application, Ser. No. 61/946,679, filed on Feb. 28, 2014.

### BRIEF DESCRIPTION OF FIGURES

The invention may be better understood, but is not limited, by reference to the accompanying figures, which are briefly described below.

FIG. 1A is an exploded perspective view illustrating an embodiment of the invention when used in connection with a flashlight/laser combination device.

FIG. 1B is an alternate perspective view of the embodiment of the invention shown in FIG. 1A.

FIG. 1C is an alternate perspective view of the embodiment of the invention shown in FIG. 1A.

FIG. 2A is an exploded perspective view illustrating aspects of an embodiment of the invention.

FIG. 2B is an alternate perspective view of the aspects of an embodiment of the invention as shown in FIG. 2A.

FIG. 2C is an alternate perspective view of the aspects of an embodiment of the invention as shown in FIG. 2A.

FIG. 2D is an alternate perspective view of an assembly of the components shown in FIG. 2C.

FIG. 2E is an alternate view of aspects of the embodiment of the invention as shown in FIG. 2D.

FIG. 2F is an exploded view of the aspects of the embodiment of the invention as shown in FIG. 2E.

FIG. 2G is an alternate perspective view to help illustrate aspects of an embodiment of the invention.

FIG. 2H is an alternate perspective view of what is shown in FIG. 2G.

FIG. 3A is a cut-away view illustrating aspects of an embodiment of the invention.

FIG. 3B is an alternate perspective view illustrating aspects of an embodiment of the invention.

FIG. 3C is a cut-away view illustrating aspects of an embodiment of the invention.

FIG. 3D is an alternate perspective view illustrating aspects of an embodiment of the invention.

FIG. 3E is a cut away view illustrating aspects of an embodiment of the invention.

FIG. 3F is an alternate perspective view illustrating aspects of an embodiment of the invention.

FIG. 3G is a cut-away view illustrating aspects of an embodiment of the invention.

FIG. 3H is an alternate perspective view illustrating aspects of an embodiment of the invention.

FIG. 3I is a cut-away view illustrating aspects of an embodiment of the invention.

FIG. 3J is an alternate perspective view illustrating aspects of an embodiment of the invention.

FIG. 4A is an alternate perspective view illustrating aspects of an embodiment of the invention when used in connection with a flashlight, laser combination.

FIG. 4B is an alternate perspective view illustrating aspects of an embodiment of the invention as shown in FIG. 4A, but not mounted and unsecured.

FIG. 4C is an alternate perspective view illustrating aspects of an embodiment of the invention as shown in FIG. 4B.

FIG. 4D is an alternate perspective view illustrating aspects of an embodiment of the invention as shown in FIG. 4B, with the arm in a grasping position.

FIG. 4E is an alternate perspective view of illustrating aspects of an embodiment of the invention as shown in FIG. 4D.

FIG. 4F is an alternate perspective view illustrating aspects of an embodiment of the invention when used in connection with a flashlight, laser combination while mounted and secured to a mounting rail.

FIG. 4G is an alternate perspective view illustrating aspects of an embodiment of the invention as shown in FIG. 4F.

### DETAILED DESCRIPTION

This invention is an apparatus that may be configured to quickly attach or, if appropriate, detach one device to or from another. This quick and easy method of attaching or detaching devices is not available in the prior art.

In one or more embodiments, the invention comprises a pivoting clamp arm, one or more securing bolts or similar structure, one or more hinge bolts or similar structure, and one or more springs. The invention, however, is not limited to any specific number of securing bolts, springs or pivoting clamp arms.

The apparatus of the present invention can, for example, be used to attach such devices as a laser sight with or without a flashlight combination device, to a firearm. By way of other examples, the apparatus can be used to attach optical sighting devices, iron sighting devices, cameras, grips, bipods, and slings to a rail or similar structure on a firearm or other devices.

The apparatus is also not limited to mounting to a single type of mounting rail, but can also be used to attach to many different kinds of devices that have different kinds of mounting rails, graspable grooves, or similar type of features, structures, or configurations that are able to be grasped. Examples of such devices include bicycles, helmets, cameras, tripods, bipods, automobiles, watercraft, power tools, safes, TVs, audio equipment, tablets & mobile phones, exercise equipment, furniture and sports equipment.

To help understand the invention, the following discussion is provided with reference to the certain embodiments shown in the accompanying Figures. The invention, however, should not be considered to be limited to those embodiments.

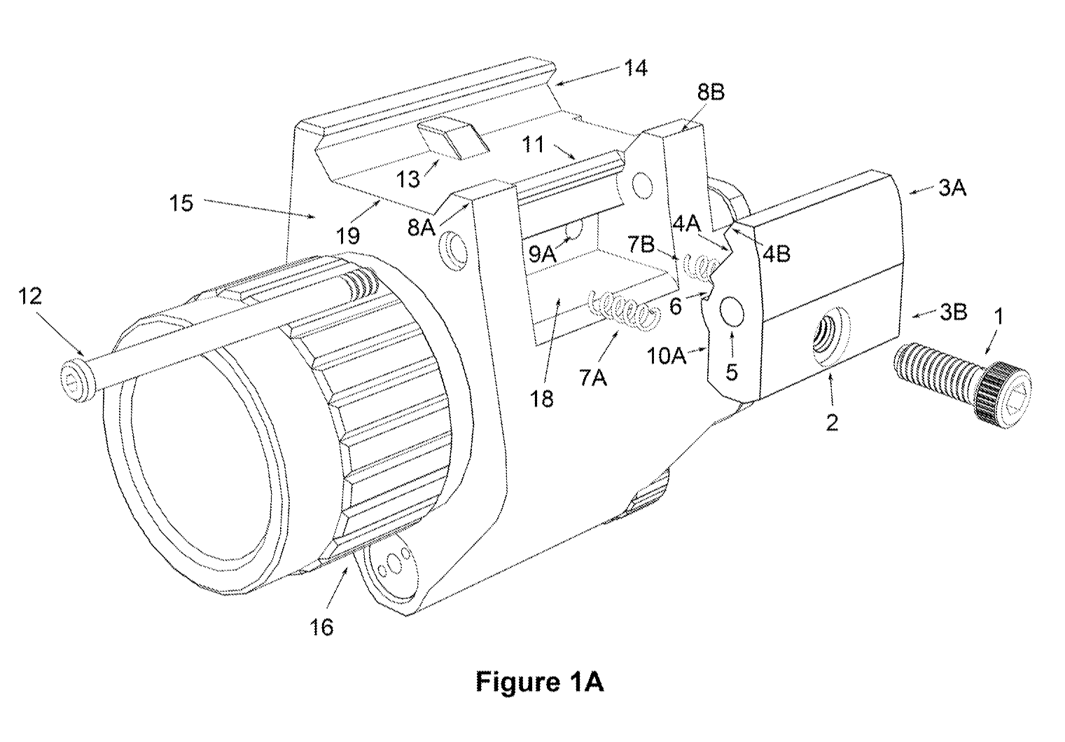

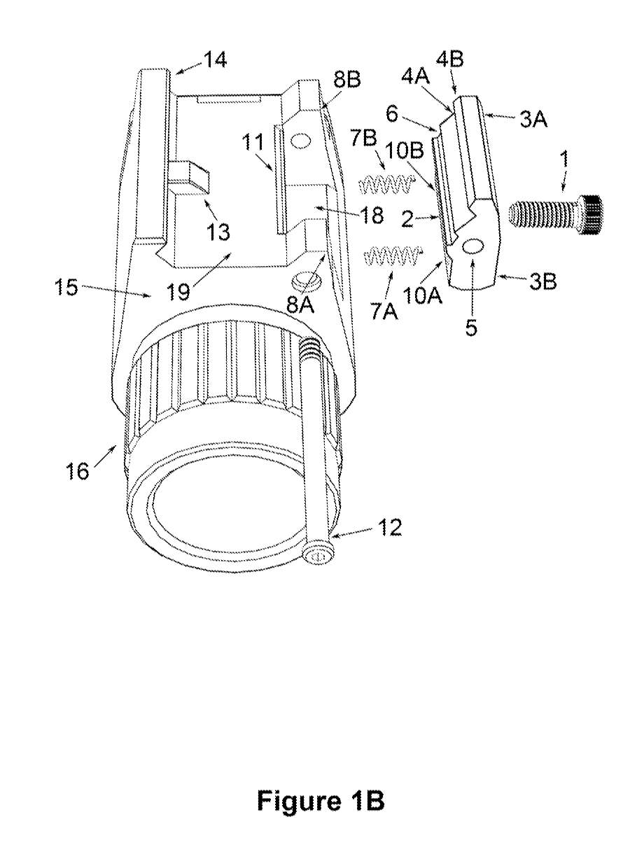

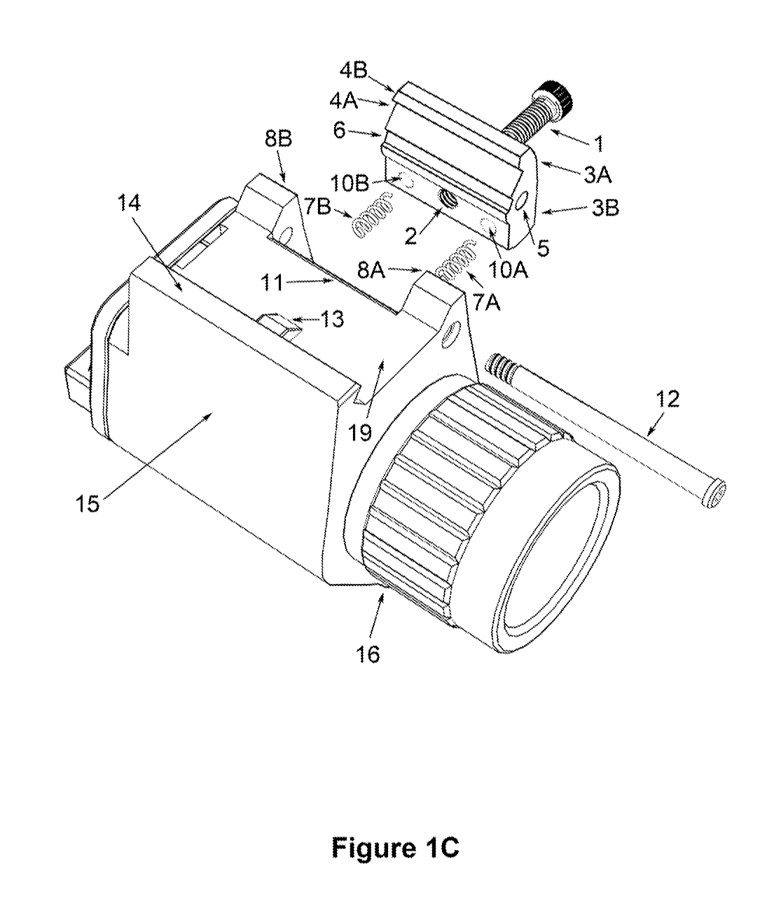

FIG. 1A is an exploded illustration of one or more embodiments of the invention when used in connection with a flashlight/laser combination device 16. From this view, clamp arm 3 (comprising clamp arm subparts 3A and 3B) is shown with locking bolt 1 positioned in front of locking bolt hole 2. Hinge bolt 12 is shown relative to hinge shoulders 8A and 8B, with through holes, and hinge pivot hole 5. To help explain the motion of clamp arm 3, a portion of clamp arm 3 is labeled as 3A and another portion is labeled as 3B. Pivot stopper groove 6 is also shown on clamp arm 3, which when assembled engages pivot stopper angle 11. While hinge bolt 12 is shown as a bolt, hinge bolt 12 may be a pin or rod or any similar structure that allows clamp arm 3 to pivot between hinge shoulders 8A and 8B. Hinge bolt 12 may be of any length sufficient to assist the pivoting function of clamp arm 3. Within mounting area 19, a stabilizing key bar 13 is shown connected to fixed mounting clamp arm 14. In one or more embodiments, stabilizing key bar 13 is optional and may be used to prevent the pivoting clamp arm 3 from moving within the mounting area. Also, from this view, hinge swing cavity 18 is shown recessed within device main body 15. In one or more embodiments, springs 7A and 7B are suspended behind pivoting clamp arm 3, which when assembled fit into spring holes 9A and 9B. In one or more embodiments, spring holes 9A and 9B may be recessed within device main body 15. While two springs are shown, there is no requirement for any specific number of springs, and even a single spring or similar structure may be used.

FIGS. 1B and 1C are alternative views of one or more embodiments of the invention shown in FIG. 1A. In FIG. 1C, optional matching recessed spring holes 10A and 10B can be seen positioned partially within pivoting clamp arm 3.

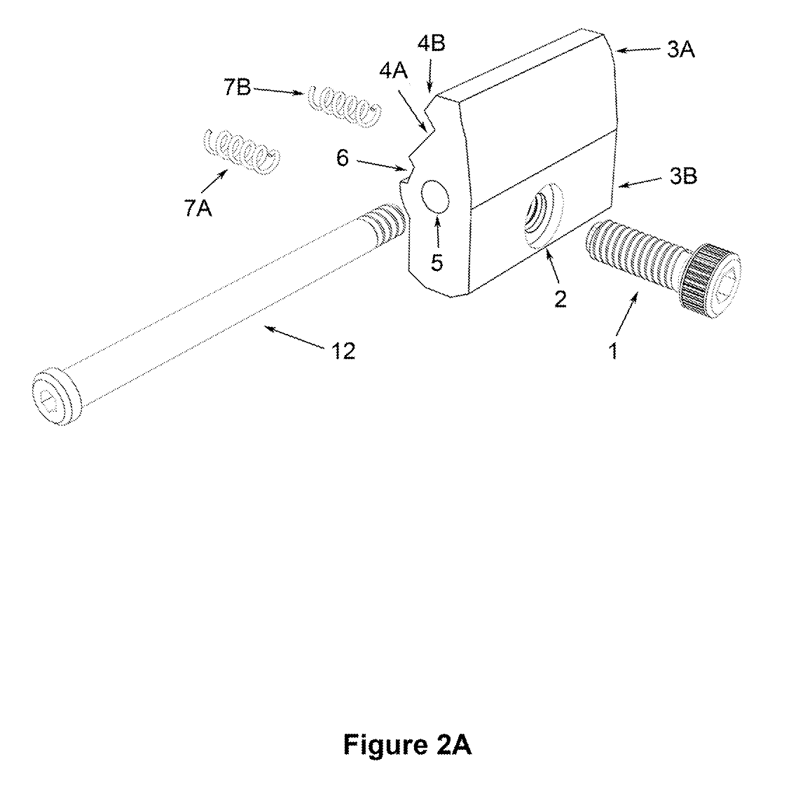

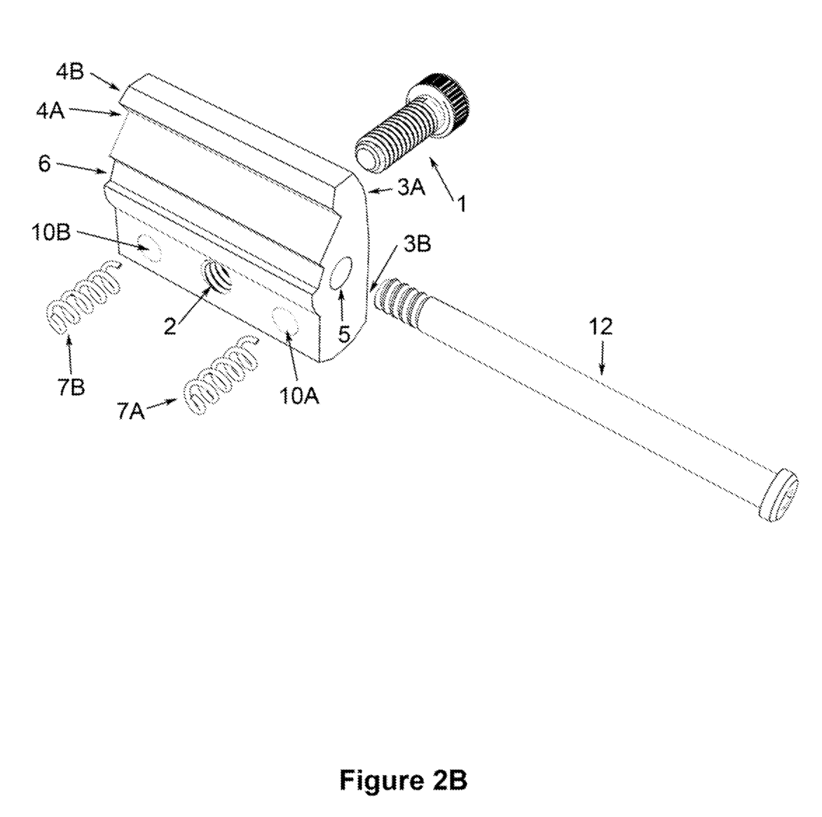

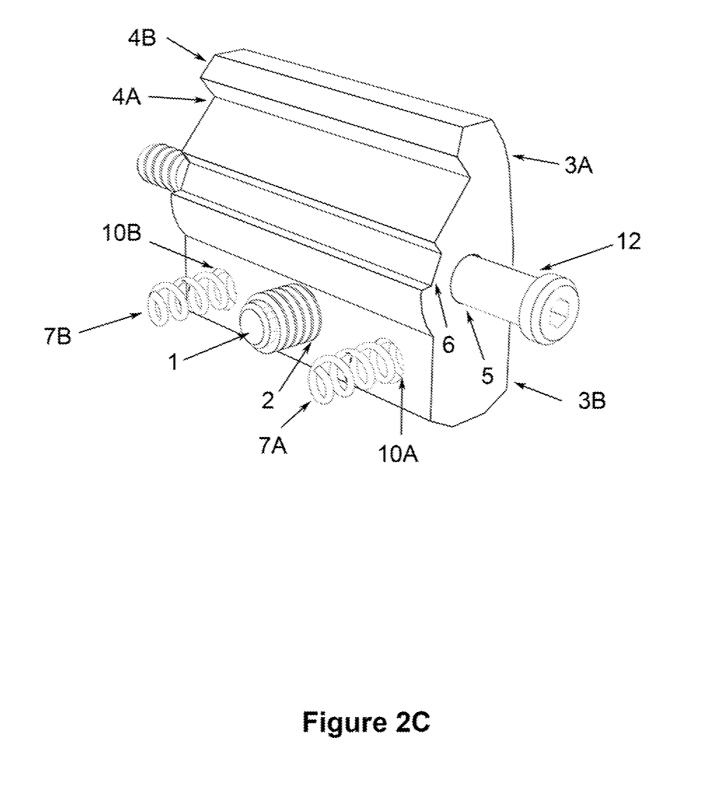

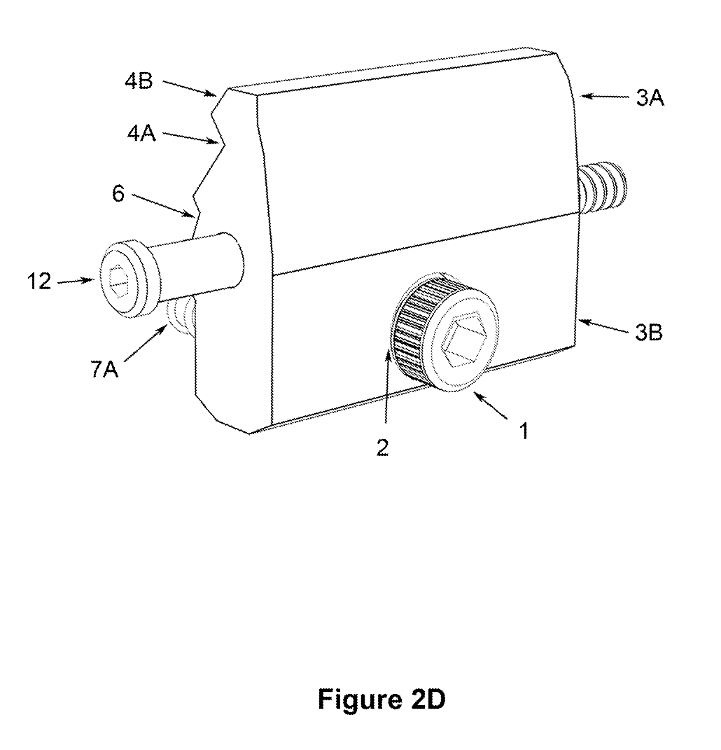

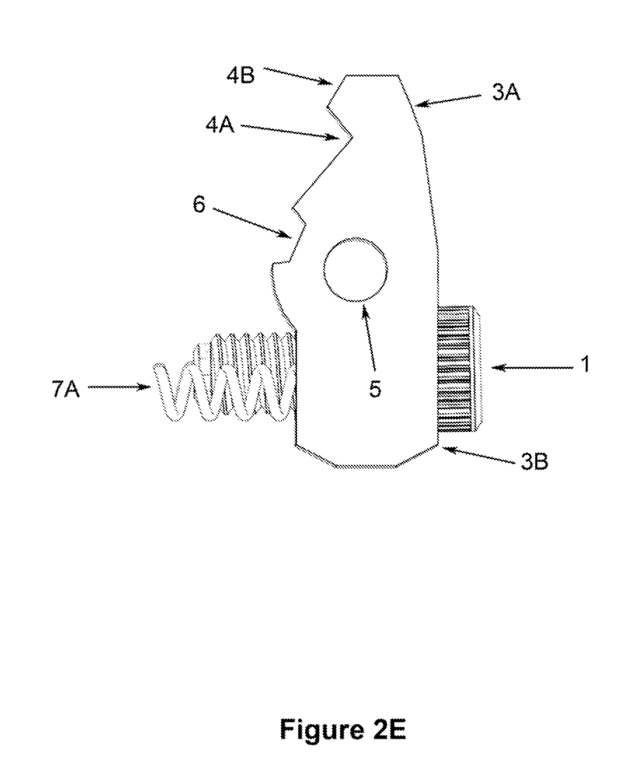

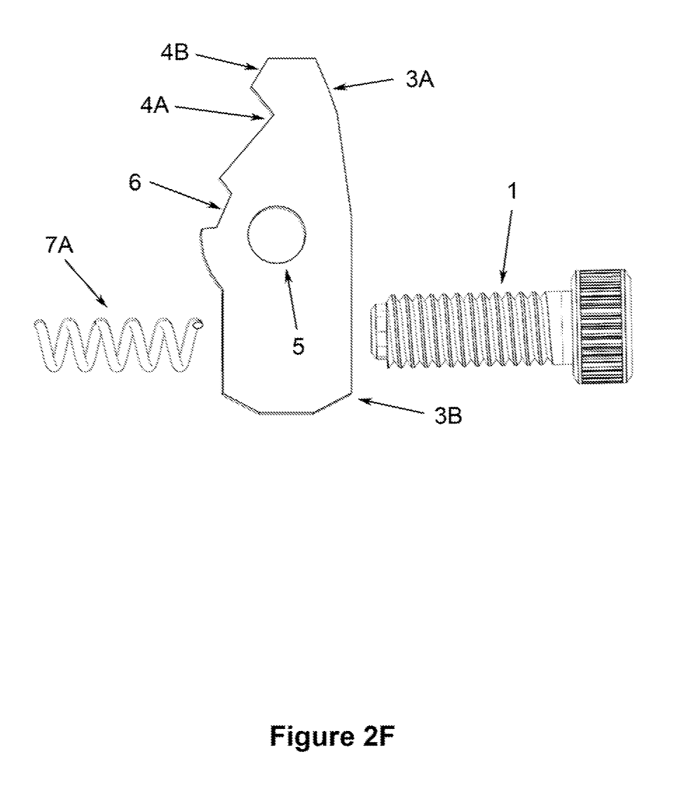

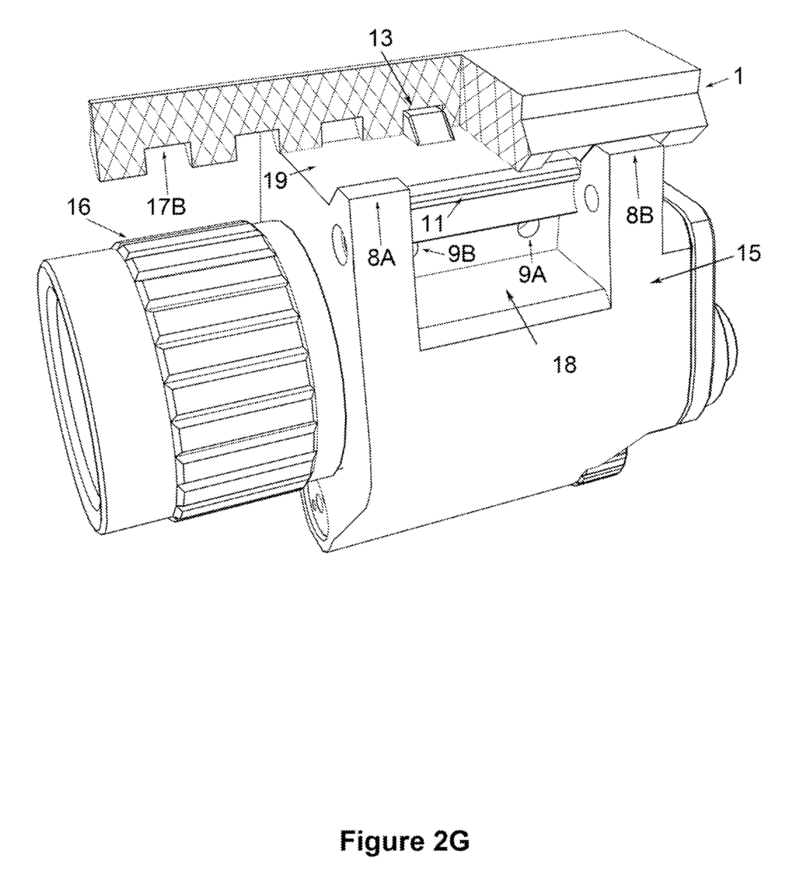

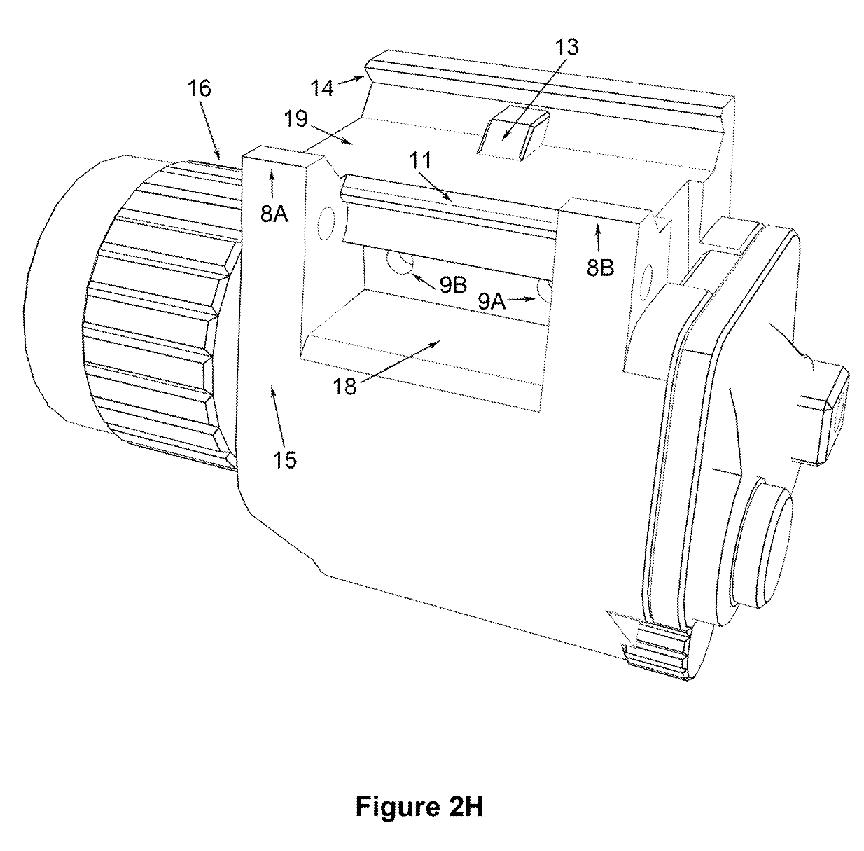

FIG. 2A is an exploded illustration of pivoting clamp arm 3 positioned relative to locking bolt 1, hinge bolt 12, and springs 7A and 7B. In one or more embodiments, locking bolt hole 2 optionally comprises a small recess for the head of locking bolt 1.

FIGS. 2B and 2C are alternative views of the components of one or more embodiments of the invention shown in FIG. 2A. In FIG. 2B, locking bolt hole 2 is shown positioned between optional matching recessed spring holes 10A and 10B. In FIG. 2C, an assembly of the components of one or more embodiments of the invention is shown, but without showing hinge shoulders 8A and 8B. In this view, hinge bolt 12 is positioned within hinge pivot hole 5. Springs 7A and 7B are positioned partially within optional recessed spring holes 10A and 10B. Locking bolt 1 is positioned within locking bolt hole 2 protruding out of pivoting clamp arm 3 so that when fully assembled, the protruding portion of locking bolt 1 pushes against device main body 15 shown in FIG. 1A, causing pivoting clamp arm 3 to pivot closed.

FIGS. 2D and 2E are alternative views of one or more embodiments of the invention shown in FIG. 2C. In FIGS. 2D and 2E, locking bolt 1 is shown positioned within locking bolt hole 2, with hinge shoulders 8A and 8B omitted for clarity. Springs 7A and 7B are positioned partially within optional recessed spring holes 10A and 10B. In one or more embodiments, pivoting clamp arm 3 includes groove 4A, rail chamfered edge 4B, and/or pivot stopper groove 6.

FIG. 2F is an exploded view of one or more embodiments of the invention shown in FIG. 2E.

FIG. 2G is a perspective view of one or more embodiments of the invention showing device main body 15, hinge swing cavity 18, and a cut-away view of mounting rail 17 positioned within mounting area 19. Portions of mounting rail 17 are also referred to as 17A and 17B for convenience. In FIG. 2G, mounting rail 17 is shown as a cut-away view so the fitting of stabilizing key bar 13 is visible as it is positioned within one of mounting rail slots 17B. Additionally, hinge swing cavity 18 is shown recessed in device main body 15.

FIG. 2H is an alternate view of one or more embodiments of the invention shown in FIG. 2G. In this view, mounting clamp arm 14 is shown with stabilizing key bar 13. The pivot stopper angle 11 is positioned between shoulders 8A and 8B relative to mounting area 19.

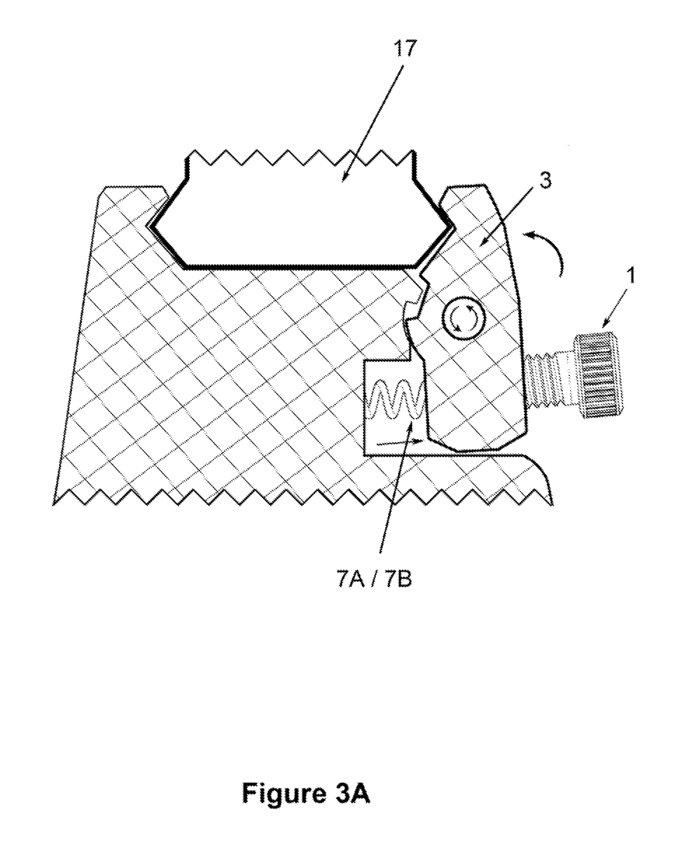

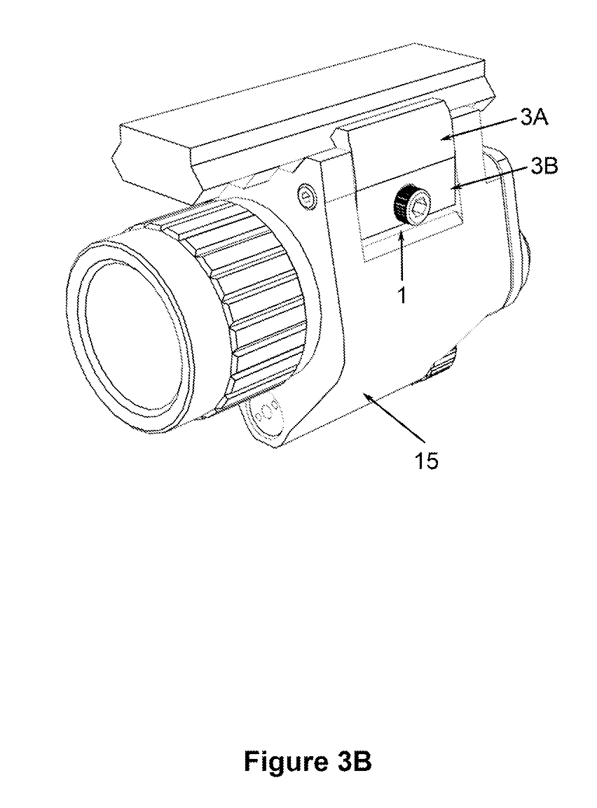

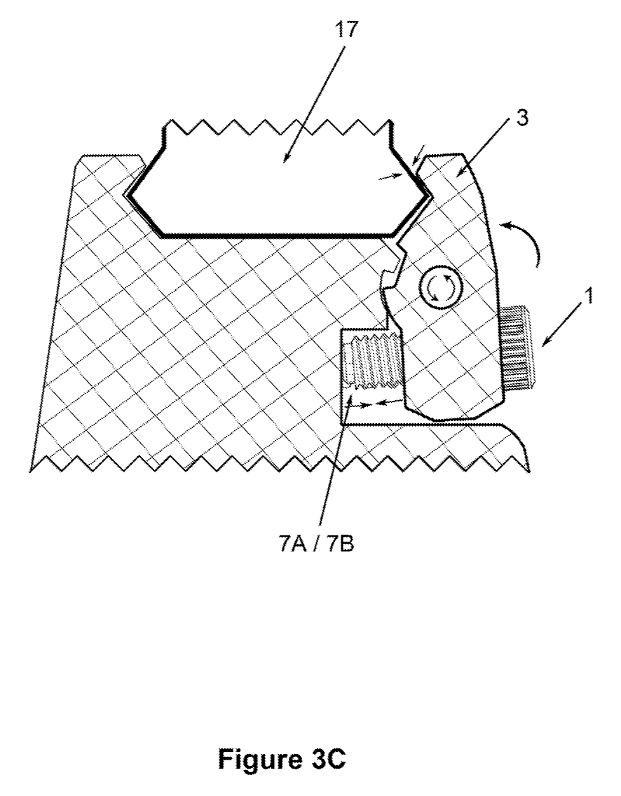

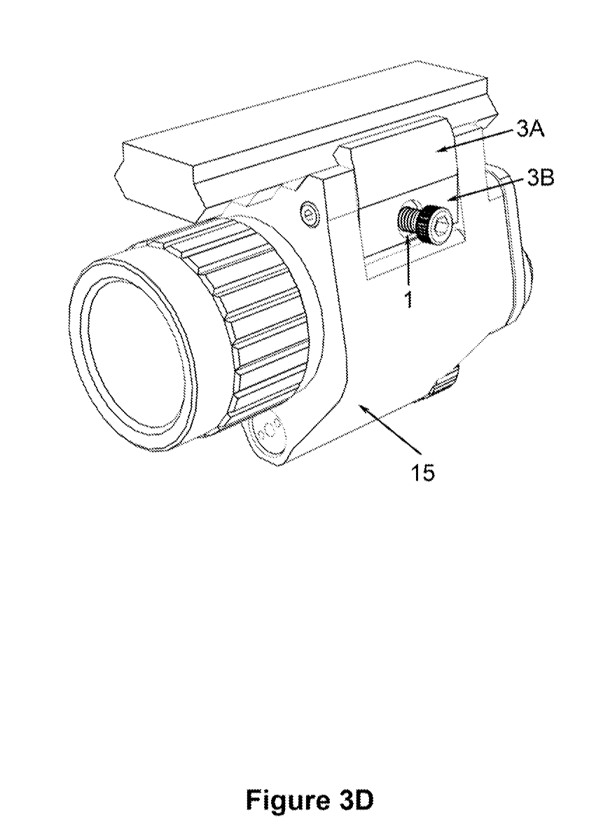

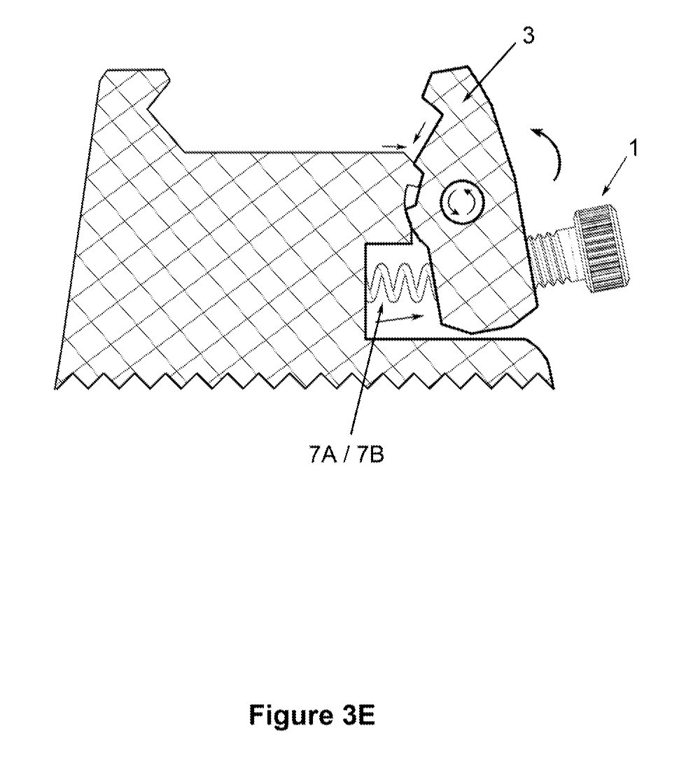

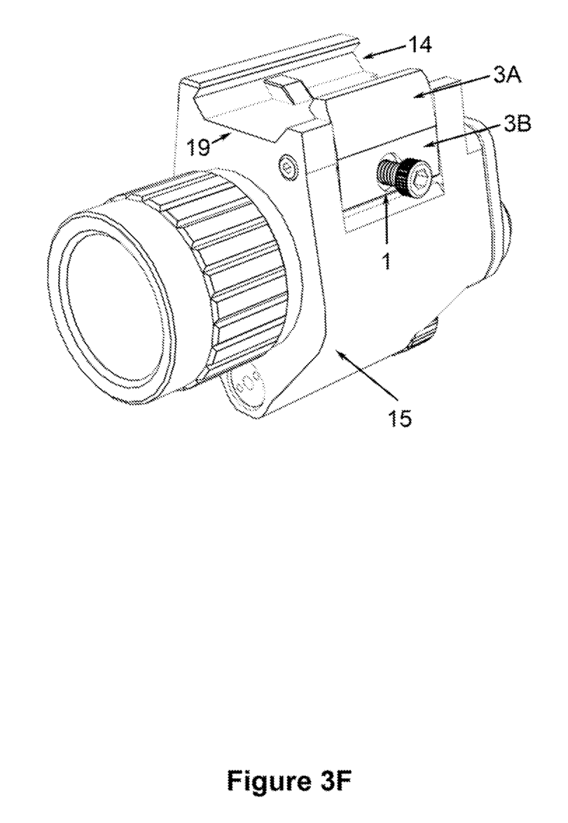

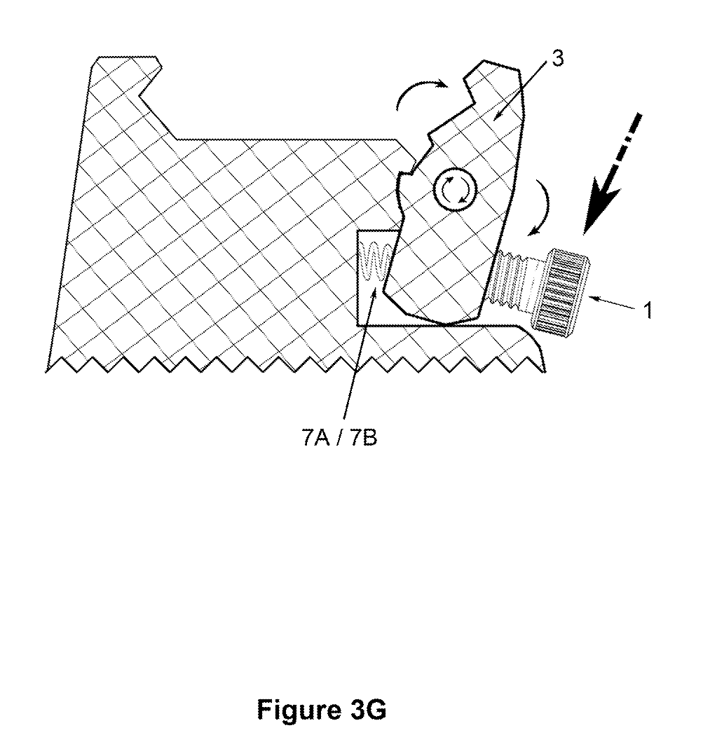

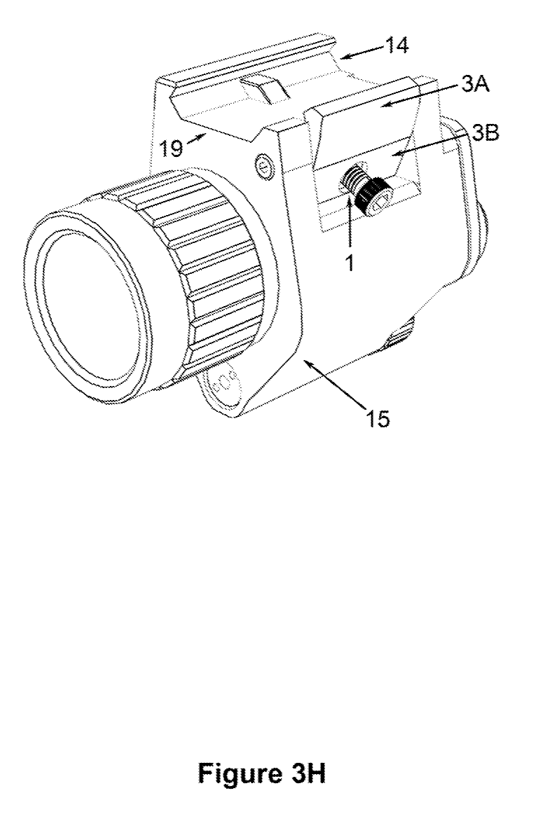

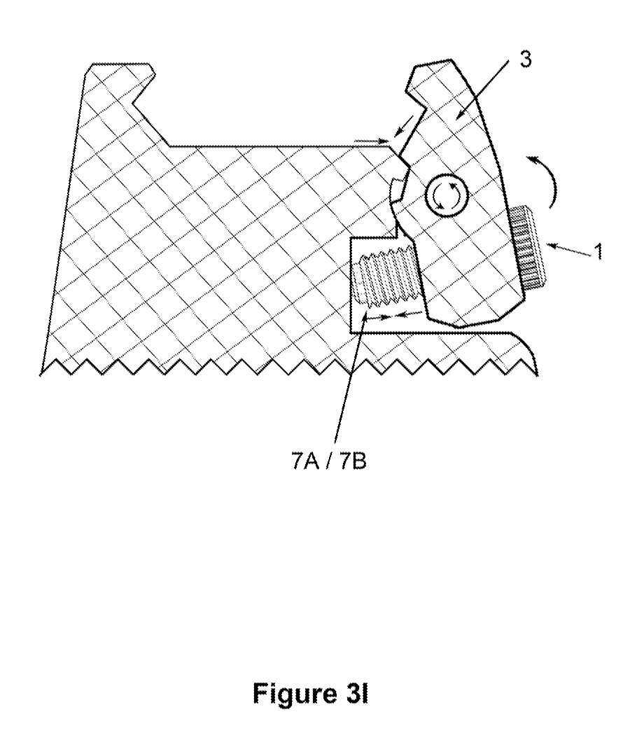

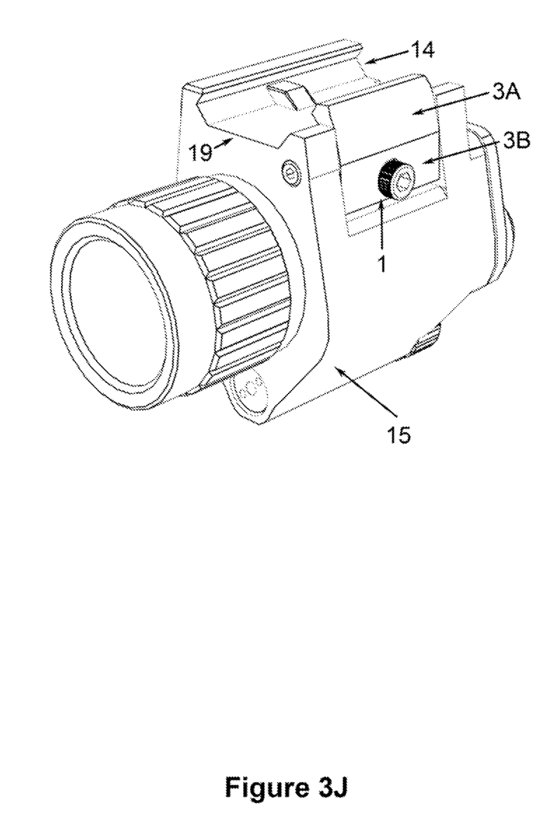

FIG. 3A is a cut away internal view of one or more embodiments of the invention showing the front of pivoting clamp arm 3 as mounted to rail 17. Springs 7A and 7B push on the bottom of pivoting clamp arm 3 at 3B causing pivoting clamp arm 3 to pivot on hinge bolt 12. The resulting force causes pivoting clamp arm 3 at 3A to pivot closed on rail 17 at 17A, thereby securing pivoting clamp arm 3 to rail 17.

FIGS. 3B, 3C, and 3D are alternative views of one or more embodiments of the invention shown in FIG. 3A. In FIG. 3C the pivoting clamp arm 3 is closed, mounted to rail 17 with the assistance of locking bolt 1.

FIG. 3E is a cut away internal view of one or more embodiments of the invention showing the front of pivoting clamp arm 3 when it is not mounted to a rail. In this view, clamp arm 3 is in the closed position and its motion is stopped by pivot stopper groove 6 engaging pivot stopper angle 11. Springs 7A and 7B are pushing on pivoting clamp arm 3 at 3B causing clamp arm 3 to pivot around hinge bolt 12 and close.

FIG. 3F is an alternate view of one or more embodiments of the invention shown in FIG. 3E.

FIG. 3G is a cut-away internal view of one or more embodiments of the invention showing the front of clamp arm 3 when it is not mounted to a rail. In this view, clamp arm 3 is in the grasping position, but not secured to a rail, such as mounting rail 17. In this view, an external force, such as the force applied by the user's finger in the direction of the large arrow, pushes down and inward on locking bolt 1 causing arm clamp arm 3 to pivot open. When clamp arm 3 pivots open, springs 7A and 7B are compressed within the hinged swing cavity 18.

FIG. 3H is an alternate view of one or more embodiments of the invention shown in FIG. 3G.

FIG. 3I is a cut away internal view of one or more embodiments of the invention showing the front of clamp arm 3 when it is not mounted to a rail. In this view, clamp arm 3 is closed, and the motion is stopped when pivot stopper groove 6 and pivot stopper angle 11 meet.

FIG. 3J is an alternate view of one or more embodiments of the invention shown in FIG. 3I.

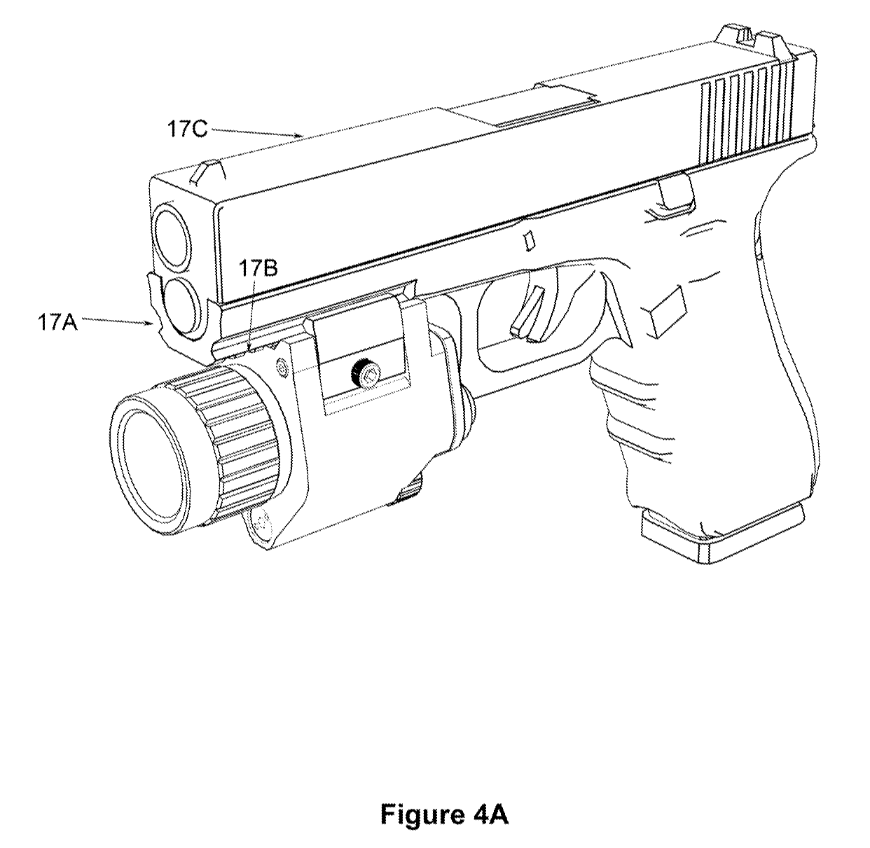

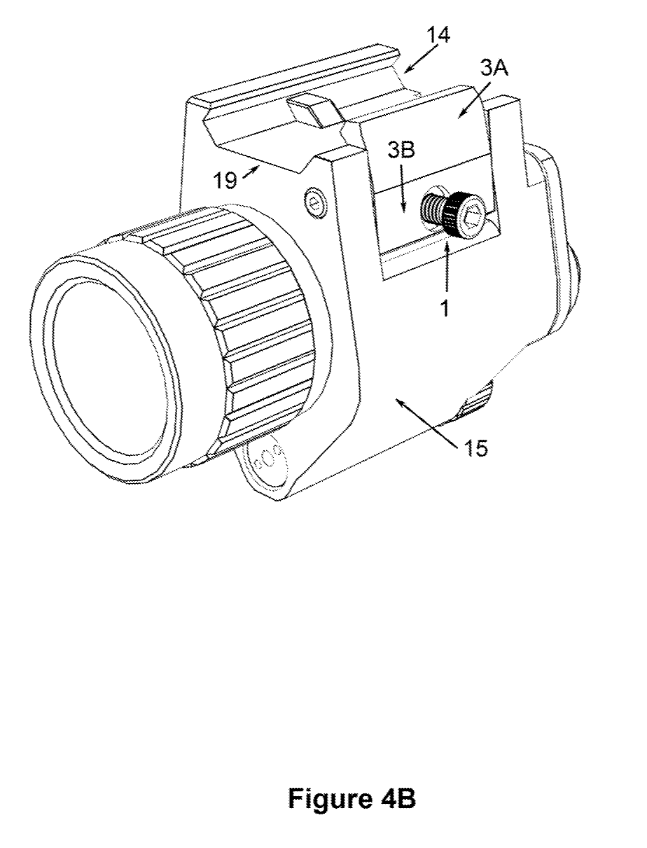

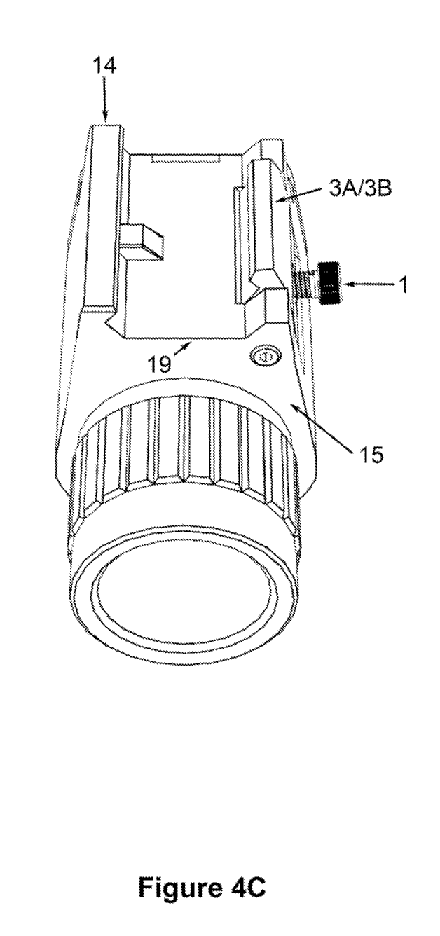

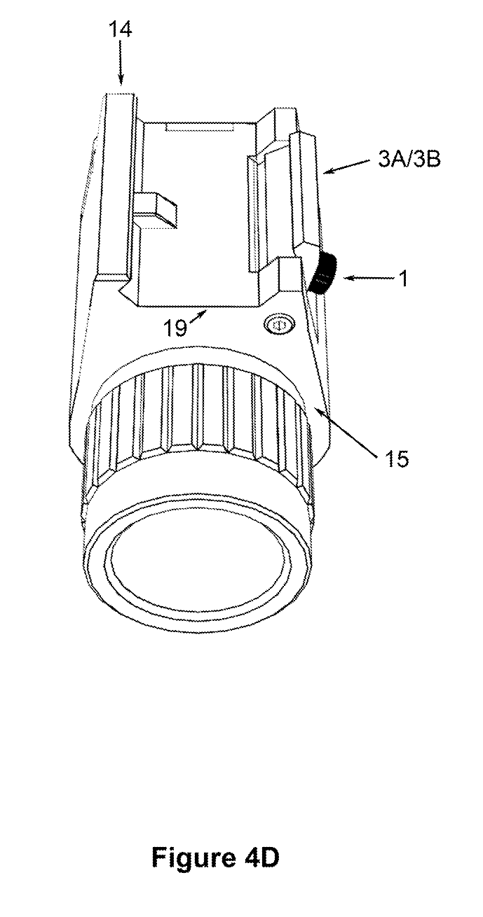

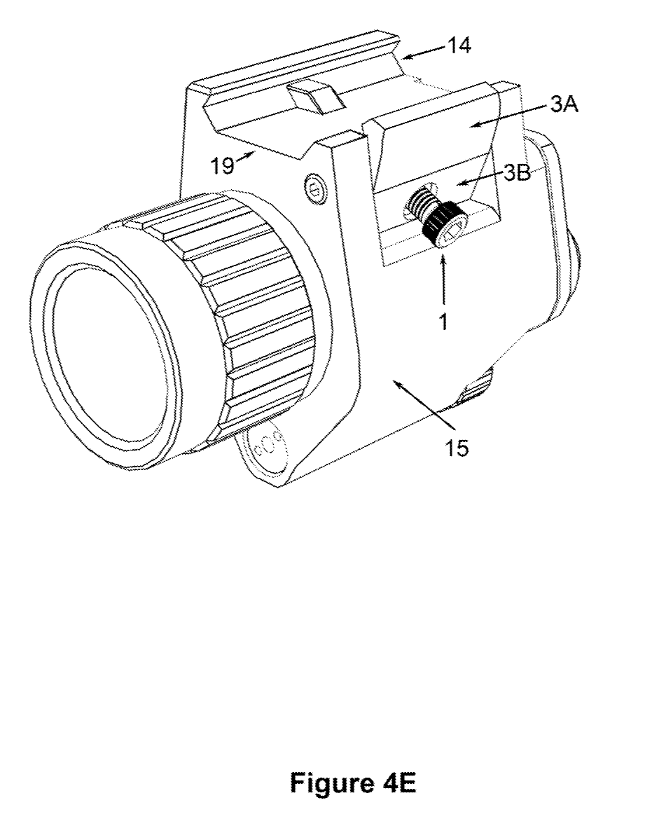

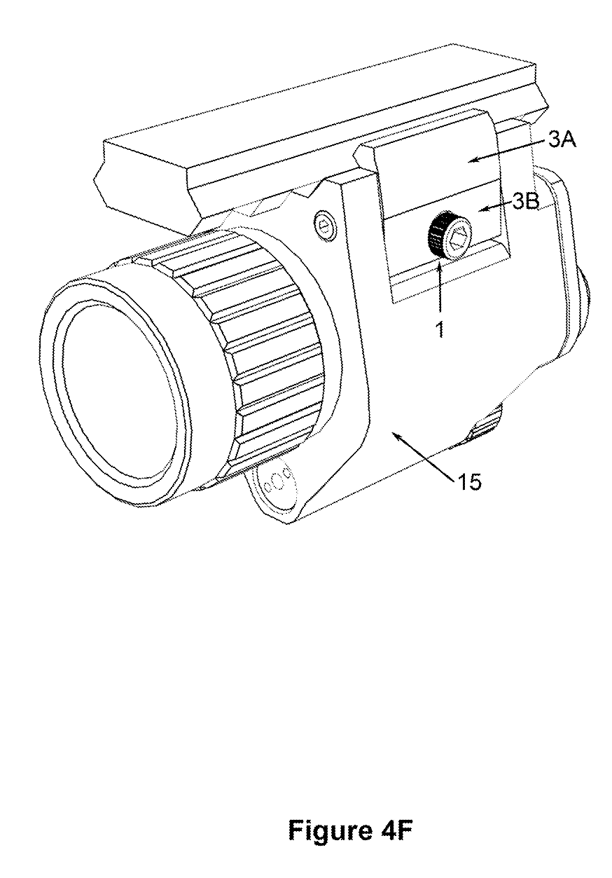

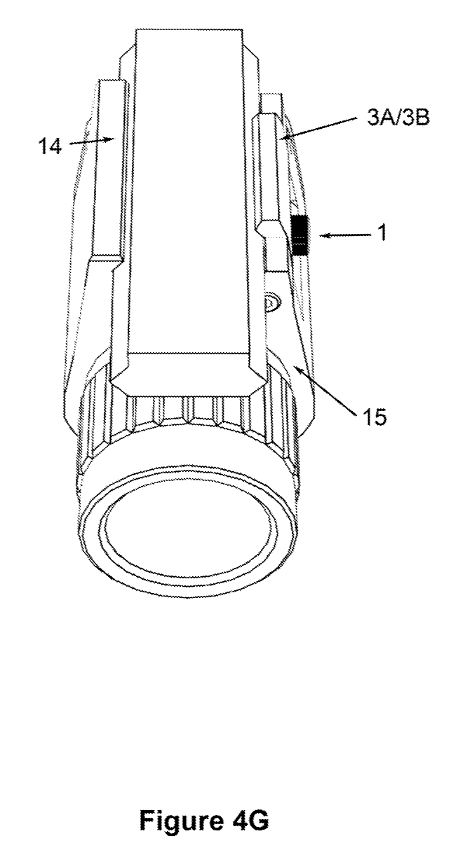

FIG. 4A is a perspective view of one or more embodiments of the invention shown when used in connection with a flashlight/laser combination device 16. The invention is shown mounted to mounting rail 17 (comprising mounting rail subparts 17A and 17B) of, for example, a firearm 17C. Mounting rail 17, however, is not necessarily part of a firearm, and may be any mounting rail, graspable groove, or similar type of feature, structure, or configuration that is able to be grasped.

FIGS. 4B and 4C are alternate views of one or more embodiments of the invention shown in FIG. 4A, but not yet mounted to mounting rail 17.

FIGS. 4E and 4D are alternate views of one or more embodiments of the invention shown in FIG. 4A, but not yet mounted to mounting rail 17, with the clamp arm 3 in the grasping position.

FIGS. 4F and 4G are alternate views of one or more embodiments of the invention shown in FIG. 4A, and showing it mounted and secured to mounting rail 17.

What is claimed is:

1. An apparatus comprising a clamp arm, a securing member, a hinge member, and one or more springs.

2. The apparatus of claim 1 wherein the securing member is a bolt.

3. The apparatus of claim 1 wherein the hinge member is a bolt.

4. The apparatus of claim 1 wherein the clamp arm is configured to pivot around said hinge member.

5. The apparatus of claim 4 wherein the clamp arm is configured to grasp a mounting rail.

6. An apparatus for securing a device to a mounting rail comprising a clamp arm, a securing member, a hinge member, and one or more springs, wherein the clamp arm is configured to pivot around said hinge member and wherein the clamp arm is configured to grasp a mounting rail.

7. A method of securing a device to a mounting rail, comprising the steps of:
attaching said device to a clamp arm using a securing member;
applying force to a hinge member, causing the hinge member to pivot around said clamp arm into an open position and compress one or more springs;
positioning said clamp arm adjacent to a mounting rail; and
releasing the force applied to said hinge member, causing said one or more springs to pivot said clamp arm into a closed position, thereby grasping said mounting rail.
